(19) United States
(12) Patent Application Publication
(10) Pub. No.: US 2024/0330556 A1
(43) Pub. Date: Oct. 3, 2024

(54) LOCATION AWARE TIMING ANALYSIS OF A DIGITAL INTEGRATED CIRCUIT

(71) Applicant: INTERNATIONAL BUSINESS MACHINES CORPORATION, ARMONK, NY (US)

(72) Inventors: JAMES J. ENGEL, CAMBRIDGE, VT (US); JENNIFER ELIZABETH BASILE, POUGHKEEPSIE, NY (US); HEMLATA GUPTA, HOPEWELL JCT, NY (US); MICHAEL HEMSLEY WOOD, WILMINGTON, DE (US); KERIM KALAFALA, RHINEBECK, NY (US); VASANT RAO, FISHKILL, NY (US); ALEXANDER JOEL SUESS, HOPEWELL JUNCTION, NY (US)

(21) Appl. No.: 18/192,839

(22) Filed: Mar. 30, 2023

(51) Int. Cl. G06F 30/367

(52) U.S. Cl. CPC G06F 30/367; G06F 2119/12

(57) ABSTRACT

Timing analysis of a digital integrated circuit includes determining an initial delay value for a gate of an integrated circuit design. The gate is located within a predefined area of the integrated circuit design. A first scale factor is calculated based on a number of switching transistors within the predefined area, and a second scale factor is calculated based on a voltage drop value associated with the predefined area. An updated delay value for the gate is calculated based on the initial delay value, the first scale factor, and the second scale factor.

### BACKGROUND

### Field of the Disclosure

The field of the disclosure is data processing, or, more specifically, methods, apparatus, and products for performing location aware timing analysis of a digital integrated circuit.

### Description of Related Art

Fabrication of an integrated circuit or chip includes several steps to finalize such as logic design, analysis, and physical implementation. The chip may be designed according to a hierarchical design methodology such that the chip is divided into functional circuit components or elements. The logic design and component placement must result in a physical implementation that meets the design and performance requirements of the chip. To ensure that the design requirements are met, design analysis such as timing analysis of the chip is performed at different stages and levels of design.

### SUMMARY

Exemplary embodiments include a method, apparatus, and computer program product to perform timing analysis of an integrated circuit. An embodiment of a method for timing analysis of a digital integrated circuit includes determining an initial delay value for a gate of an integrated circuit design. The gate is located within a predefined area of the integrated circuit design. A first scale factor is calculated based on a number of switching transistors within the predefined area, and a second scale factor is calculated based on a voltage drop value associated with the predefined area. An updated delay value for the gate is calculated based on the initial delay value, the first scale factor, and the second scale factor.

An embodiment of an apparatus for timing analysis of an integrated circuit includes a computer processor, and a computer memory operatively coupled to the computer processor. The computer memory having disposed within it computer program instructions that, when executed by the computer processor, cause the apparatus to: determine an initial delay value for a gate of an integrated circuit design, the gate being located within a predefined area of the integrated circuit design; calculate a first scale factor based on a number of switching transistors within the predefined area; calculate a second scale factor based on a voltage drop value associated with the predefined area; and calculate an updated delay value for the gate based on the initial delay value, the first scale factor, and the second scale factor.

An embodiment of a computer program product for timing analysis of an integrated circuit includes the computer program product disposed upon a computer readable medium. The computer program product comprises computer program instructions that, when executed, cause a computer to: determine an initial delay value for a gate of an integrated circuit design, the gate being located within a predefined area of the integrated circuit design; calculate a first scale factor based on a number of switching transistors within the predefined area; calculate a second scale factor based on a voltage drop value associated with the predefined area; and calculate an updated delay value for the gate based on the initial delay value, the first scale factor, and the second scale factor.

The foregoing and other objects, features and advantages of the disclosure will be apparent from the following more particular descriptions of exemplary embodiments of the disclosure as illustrated in the accompanying drawings wherein like reference numbers generally represent like parts of exemplary embodiments of the disclosure.

### BRIEF DESCRIPTION OF THE DRAWINGS

FIG. 1 shows a block diagram of an example computing system configured for performing location aware timing analysis of a digital integrated circuit according to some embodiments of the present disclosure.

FIG. 2 shows a block diagram of a flow for performing location aware timing analysis of a digital integrated circuit according to some embodiments of the present disclosure.

FIG. 3 is a flowchart of an example method for performing location aware timing analysis of a digital integrated circuit according to some embodiments of the present disclosure.

FIG. 4 shows an example power tile grid of an integrated circuit design according to some embodiments of the present disclosure.

FIG. 5 shows an example power tile of an integrated circuit design according to some embodiments of the present disclosure.

FIG. 6 is a flowchart of another example method for example method for performing location aware timing analysis of a digital integrated circuit according to some embodiments of the present disclosure.

### DETAILED DESCRIPTION

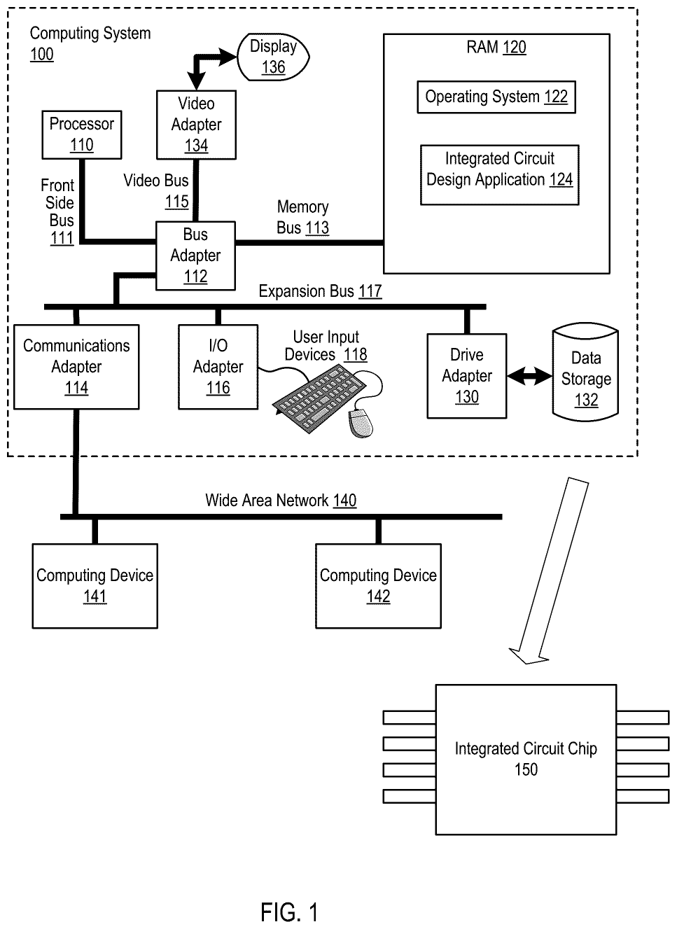

Exemplary apparatus and systems for performing location aware timing analysis in accordance with the present disclosure are described with reference to the accompanying drawings, beginning with FIG. 1. FIG. 1 sets forth a block diagram of automated computing machinery comprising an exemplary computing system 100 configured for performing location aware timing analysis of a digital integrated circuit in accordance with embodiments of the present disclosure. The computing system 100 of FIG. 1 includes at least one computer processor 110 or ‘CPU’ as well as random access memory (‘RAM’) 120 which is connected through a high speed memory bus 113 and bus adapter 112 to processor 110 and to other components of the computing system 100.

Stored in RAM 120 is an operating system 122. Operating systems useful in computers configured for performing location aware timing analysis according to embodiments of the present disclosure include UNIX™, Linux™, Microsoft Windows™, AIX™, and others as will occur to those of skill in the art. The operating system 122 in the example of FIG. 1 is shown in RAM 120, but many components of such software typically are stored in non-volatile memory also, such as, for example, on data storage 132, such as a disk drive. Also stored in RAM is an integrated circuit design application 124, including for designing digital integrated circuits such as an integrated circuit 150 and performing location aware timing analysis of the digital integrated circuit 150 in accordance with embodiments of the present disclosure according to embodiments of the present disclosure.

The computing system 100 of FIG. 1 includes disk drive adapter 130 coupled through expansion bus 117 and bus adapter 112 to processor 110 and other components of the computing system 100. Disk drive adapter 130 connects non-volatile data storage to the computing system 100 in the form of data storage 132. Disk drive adapters useful in computers configured for inserting sequence numbers into editable tables according to embodiments of the present disclosure include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example computing system 100 of FIG. 1 includes one or more input/output (′I/O′) adapters 116. I/O adapters implement user-oriented input/output through, for example, software drivers and computer hardware for controlling output to display devices such as computer display screens, as well as user input from user input devices 118 such as keyboards and mice. The example computing system 100 of FIG. 1 includes a video adapter 134, which is an example of an I/O adapter specially designed for graphic output to a display device 136 such as a display screen or computer monitor. Video adapter 134 is connected to processor 110 through a high speed video bus 115, bus adapter 112, and the front side bus 111, which is also a high speed bus.

The exemplary computing system 100 of FIG. 1 includes a communications adapter 114 for data communications with other computers and for data communications with a data communications network. Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful in computers configured for inserting sequence numbers into editable tables according to embodiments of the present disclosure include modems for wired dial-up communications, Ethernet (IEEE 802.3) adapters for wired data communications, and 802.11 adapters for wireless data communications. The communications adapter 114 of FIG. 1 is communicatively coupled to a wide area network 140 that also includes other computing devices, such as computing devices 141 and 142 as shown in FIG. 1.

As previously discussed, design analysis such as timing analysis is performed to ensure that the physical implementation of a chip design will meet requirements. For example, static timing analysis (STA) is generally performed to efficiently accomplish timing analysis without simulating the full integrated circuit. In STA, one or more timing signals are propagated through the simulated chip design from an input side to a timing point and timing values of interest are computed such as arrival time, slew, and slack. Different timing values may be associated with different clock types of the integrated circuit such as test clocks vs. functional clocks. STA is performed at different stages of the design, but analyzing the entire chip design at every stage is inefficient in terms of run-time. Instead, a hierarchical design methodology is used and timing analysis is performed at different hierarchical levels (e.g., core, unit, component) based on the needs at any given design stage.

A component of the chip may be, for example, a cell, a single logic gate or a collection of circuits configured to perform a specific task or function. Detailed analysis may be formed at the component level. For example, components may be timed using accurate timing analysis techniques that include transistor level timing tools or gate level timing tools. This type of detailed analysis may be followed by generation of abstract models that represent the relevant characteristics, such as timing characteristics, of the component in a simplified form. The generation of abstract models may be referred to as abstraction. At higher levels (e.g., unit level, core level), components are represented by abstracts for the purposes of performing the analysis. A unit comprised of several components, each associated with abstracts, may itself be abstracted. Because components are reused in different parts of the chip design at different levels of hierarchy, the same component may be part of different clock domains.

Various physical factors are involved with the calculation of delay/slew values for cells or gates in an integrated circuit design. If these physical factors are not accurately accounted for, pessimistic values must be applied to all delay/slew values within the design. As a result, timing finalization of the integrated circuit design becomes more difficult. Gate delays traditionally depend on input slew, output load, and instance voltage. Various sources of voltage variation exists including whether the power grid design is dense or sparse, switching activity, and local voltage drop. For example, a power grid may be made less dense by removing voltage staples (or straps) within the power grid to allow for routing which increases voltage drop within the power grid. In another example, switching activity such as clock gating from active to inactive often results in sudden voltages spikes. In order to accurately time an integrated circuit design, propagated delays and slews through the gates in the design need to be as close to the simulation results as possible and should take into consideration the various sources of voltage variation. A traditional method for handling the effect of physical characteristics affecting voltage variation, and thus timing, includes setting different voltage corners with more pessimistic voltage values to account for average voltage (IR) drop. However, using pessimistic timing delay values results in designers spending more time correcting perceived timing issues that are not real. In addition, the clock frequency at which design is closable is not correct and is often much slower than desired.

One or more embodiments described herein provide for performing location aware timing analysis of a digital integrated circuit in accordance with embodiments of the present disclosure. Various embodiments provide for intelligently applying scale factors to delay values based on physical characteristics of the gate to adjust delay values to eliminate or reduce the pessimistic delay values. In one or more embodiments, delays values are calculated and scaled using physical attributes of the gates such as the number of switching transistors (e.g., fins) and voltage drop values in a predefined area (e.g., a tile) or location associated with a gate, to obtain more accurate delay values. In an embodiment, a pessimistic delay value is calculated and used to calculate an initial delay value. Based on the number of switching fins in the gate and the voltage drop for the same gate, a scale factor value is derived to adjust the initial value to obtain a final scaled value to be used in timing of the integrated circuit design. For example, the initial value may be scaled to either decrease or increase the initial timing value to obtain the final scaled value. Various embodiments provide for location aware or context-sensitive timing calculations responsive to physical factors such as simultaneous fin switching within a tile, power staple configuration within a tile, and regional voltage drop.

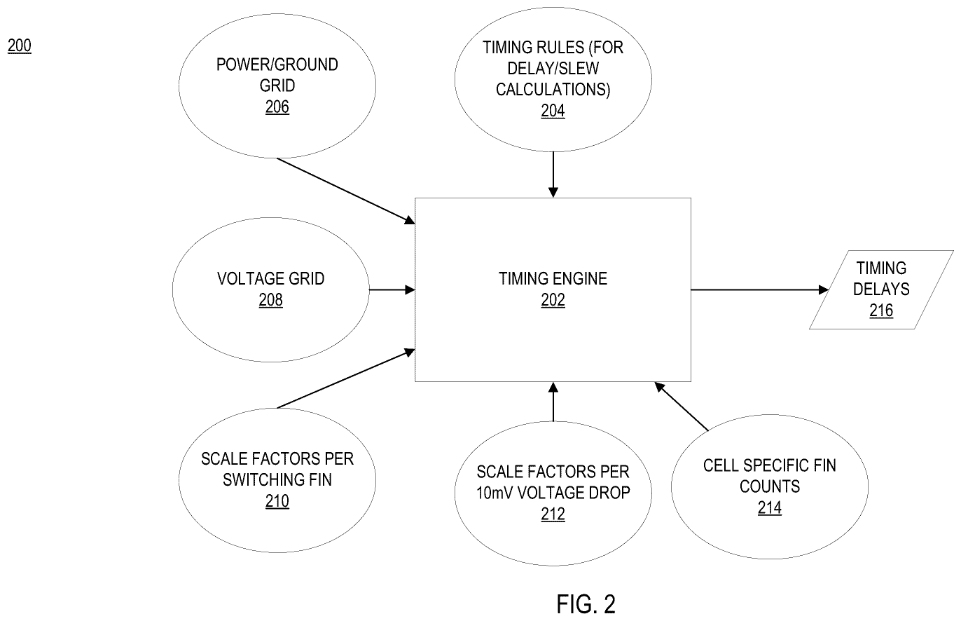

FIG. 2 shows a block diagram of a flow 200 for performing location aware timing analysis of a digital integrated circuit in accordance with embodiments of the present disclosure. In the flow 200, a timing engine 202 receives timing rules 204 for performing delay/slew calculations. In one or more embodiments, timing rules 204 are default or general rules related to timing of gates or cells that are constant regardless of gate/cell configuration. In a particular embodiment, the timing rules are loaded from a local library or from a database. In the flow 200, the timing engine 202 further receives power/ground grid configuration information 206 associated with the location of the gate. In particular embodiments, the power/ground grid configuration information includes information indicative of a degree of population or density of staples within the tile grid. A “staple” refers to a power or ground connection that are part of the power grid within a tile. Each tile or grid typically includes a number of staples. Power/ground tiles within an integrated circuit design may not have the same density of staples. Some power/ground tiles may have dense staples whereas others may be sparse. Tiles with less voltage staples typically have more voltage drop for the gates within the tile which can result in greater timing delays for the gates. The density of power grid staples can also have other impacts. More staples typically allow for better electromagnetic (EM) performance and are better for timing. Less staples allow for better routing within the tile but greater delay.

In one or more embodiments, a local power tile structure type is defined indicating a number of staple on a VDD/VSS power tile. In particular embodiments, a power tile state is referred to as either depopulated in which the number of staples is below a particular value, fully populated (V1), half populated (V2), or quarter depopulated (V3). In one or more embodiments, during flow 200 staple depopulation and/or repopulation of a tile can be enabled. In a particular embodiment, depopulation occurs for a tile if all gates are over a particular slack threshold, and depopulating will not cause any gate to drop under a given threshold. In another particular embodiment, repopulation occurs for a tile if any gate is below a given slack threshold. In particular embodiments, particular gates that are found in a tile, such as latches or local clock buffers (LCBs), cause the tile to remain populated. In another particular embodiment, empty tiles may be left populated for simplicity of implementation.

In one or more embodiments, the timing engine 202 is configured with logic to receive an instance pin of a particular gate, and use the location (e.g., an X, Y location) to access the power/ground tile of the location of the gate, determine a tile fin count for scale factor calculations as will be further described herein. The timing engine 202 computes a switching scale factor based on the population state of the tile. For example, a fully populated (V1) state switching scale factor is computed as fins count*sV1, a half populated (V2) state switching scale factor is computed as fins count*(sV1+sV2), and a quarter populated (V2) state switching scale factor is computed as fins count*(sV1+sV3). Gate delay for a gate depends on how many gates are in the same power tile as the gate, resulting in dependency on how many fins are in the same power tile. Delays may increase based on a dense population of fins.

In flow 200, the timing engine 202 further receives voltage grid information 208 including regional IR drop information for the tile. In particular embodiments, the timing engine 202 receives an IR drop file that includes a per power pin/voltage value in the tile grid. For a given instance pin (e.g., gate) the timing engine 202 utilizes the location (e.g., X, Y location) of the gate to access an IR drop tile to obtain the corresponding IR drop value to calculate an IR scaler as further described herein.

In flow 200, the timing engine 202 further receives scale factors per switching fin information 210, scale factors per 10 mV voltage drop information 212, and cell specific fin counts 214. The scale factors per switching fin information 210 is representative of a global fin delay scale factor for each switching fin of the tile. The scale factors per 10 mV voltage drop information 212 is representative of a scale factor per 10 mV IR drop voltage. In particular embodiments, the scale factors per switching fin information 210 and scale factors per 10 mV voltage drop information 212 is determined via simulation. The cell specific fin counts 214 are representative of the fin counts in the tile. In particular embodiments, the fin counts includes PFET and NFET counts in which PFETs are typically used for a power tile and NFETs are typically used for a ground tile. Although the particular embodiment is described using scale factors per 10 mV voltage drop, in other embodiments any other voltage increment may be used.

In an example computation of a scale factor for a switching fin, it is assumed that an initial delay value=d is determined from the timing rules 204 and the total switching fins in a power tile=N. Global per switching fin scale factors include Xn for fully populated, Yn for half populated, and Zn for quarter populated tiles. Out delay values are computed as follows:

$$V 1 ( fully populated ) value = d * ( 1 + ( Xn * N / 100 ) )$$

$$V 2 ( half populated ) value = d * ( 1 + ( ( Xn + Yn ) * N / 100 ) )$$

$$V 3 ( quarter populated ) value = d * ( 1 + ( ( Xn + Zn ) * N / 100 ) )$$

A switching fin scale factor is computed as follows:

$$S {F}_{V 1} = ( ( Xn ) * N / 100 )$$

$${SF}_{V 2} = ( ( Xn + Yn ) * N / 100 )$$

$$S {F}_{V 3} = ( ( Xn + Zn ) * N / 100 )$$

In particular embodiments, division by 100 may be performed at input time to avoid calculation during runtime.

In an embodiment, a computed IR drop scale factor (IR) is added to the computation of the out delay as follows:

$$V 1 ( fully populated ) value = d * ( 1 + S {F}_{V 1} + IR )$$

$$V 2 ( half populated ) value = d * ( 1 + S {F}_{V 2} + I R )$$

$$V 3 ( quarter populated ) value = d * ( 1 + S {F}_{V 3} + I R )$$

In the flow 200, the timing engine 202 calculates an overall timing delay 216 (sDelay) for the gate based on the initial delay value (Delay) and the switching fin count scale factor (sSF), and the region IR drop scale factor (sIR) as follows:

$$sDelay = Delay * ( 1 + s S F + s I R )$$

The initial delay value (Delay) is calculated from the timing rules 204. The sSF and SIR scale factors added together represent a composite scale factor.

The scale factor based on regional IR drop (sIR) is calculated based (1) a scale factor per 10 MV voltage drop (0.01 V) (sperIR) and (2) a voltage drop in a power tile ΔV.

$$The calculated IR scale factor ( sIR ) = ( ΔV / 0.01 ) * sperIR$$

The scale factor based on the switching fins count (sSF) is calculated based on (1) a fin count in a power/ground tile (n), and (2) a scale factor per switching fin in the power/ground tile (sperSF) based on the state of the power/ground tile (e.g., with fully populated staples, half populated staples, quarter populated staples).

$$The calculated SF scale factor ( s S F ) = n * sperSF$$

Accordingly, the updated timing delay 216 (sDelay) is calculated for the gate based on the initial delay value (Delay), the switching fin count scale factor (sSF), and the region IR drop scale factor (sIR).

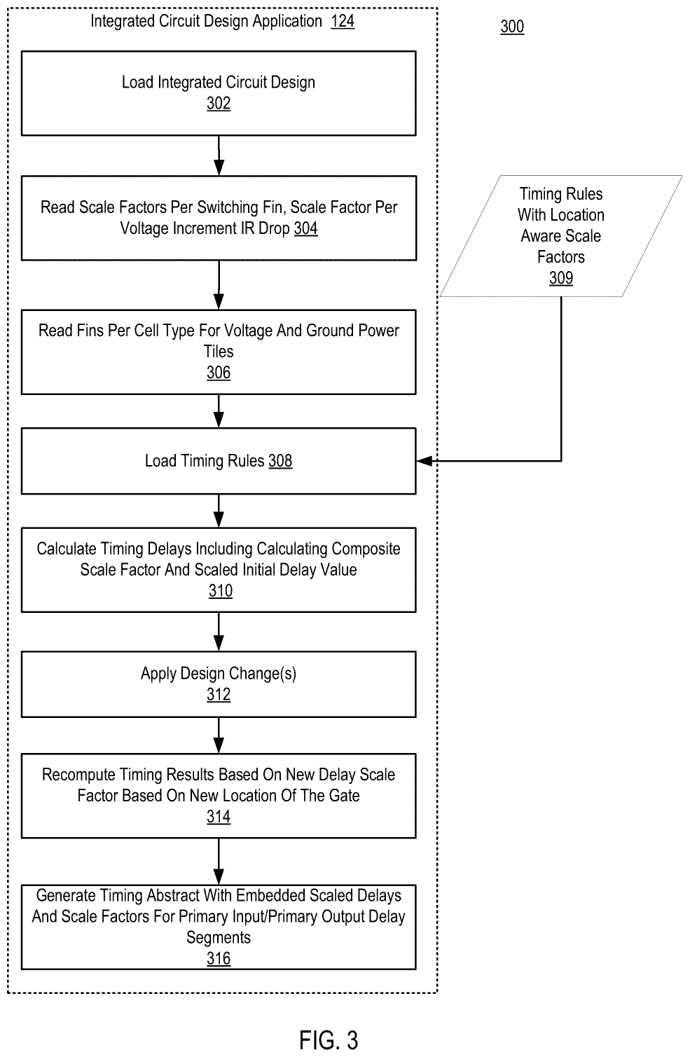

For further explanation, FIG. 3 is a flowchart of an example method 300 for performing location aware timing analysis of a digital integrated circuit according to some embodiments of the present disclosure. In a particular embodiment, the method 300 of FIG. 3 is performed utilizing the integrated circuit design application 124. The method 300 of FIG. 3 includes loading 302 an integrated circuit design into the integrated circuit design application 124. The method 300 further includes reading 304 a scale factor per switching fin and a scaler per voltage increment (e.g., 10 mV) IR drop. The method 300 further includes reading 306 the fins per cell type for voltage and ground power tiles.

The method 300 further includes loading 308 timing rules which include location aware scale factors 309. The method 300 further includes calculating 310 an updated timing delay for a gate that includes calculating a composite scale factor based on the regional IR drop scale factor and the switching fins count scale factor, and scaling the initial delay value based on the composite scale factor as described herein with respect to various embodiments.

The method 300 further includes applying 312 a design change to the integrated circuit design that includes a change in the gate location to produce a changed integrated circuit design in response to the computed updated timing delay, and recomputing 314 the timing result based on a new delay scale factor that is determined based on the new location of the gate. The method 300 further includes generating 316 a timing abstract with embedded scaled delays and scale factors for primary input/primary output (pi/po) segments of the integrated circuit design.

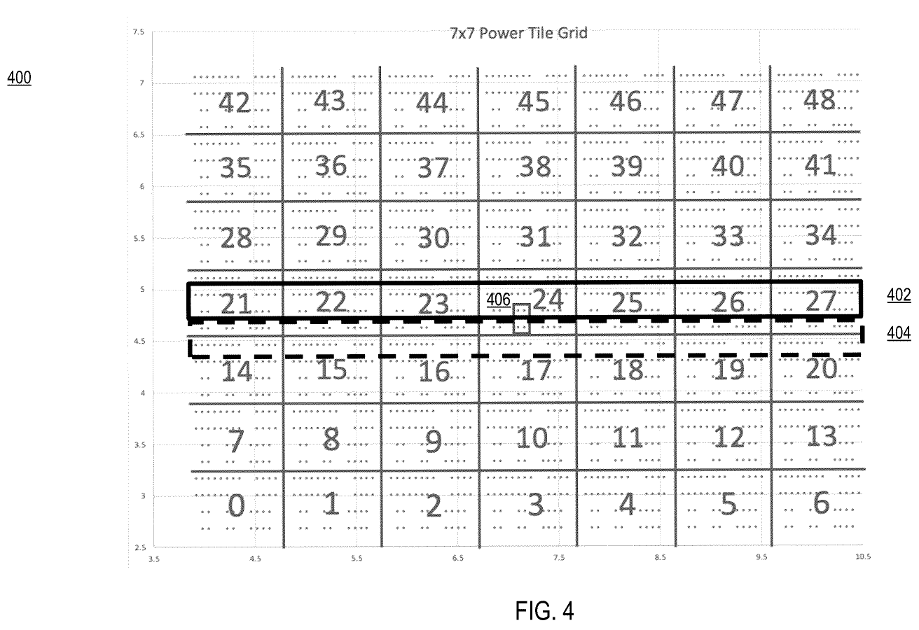

For further explanation, FIG. 4 shows an example power tile grid 400 of an integrated circuit design according to some embodiments of the present disclosure. The power tile grid 400 is shown as a 7×7 grid of rectangular tiles of the integrated circuit design. The power tile grid 400 includes VDD staples 402 extending through tiles 21-27 and VSS staples 404 extending through tiles 21-27 and 14-20. Title 24 includes a center cut 406 within tile 24 and tile 17 causing a reduction in the number of staples within tile 24 and tile 17.

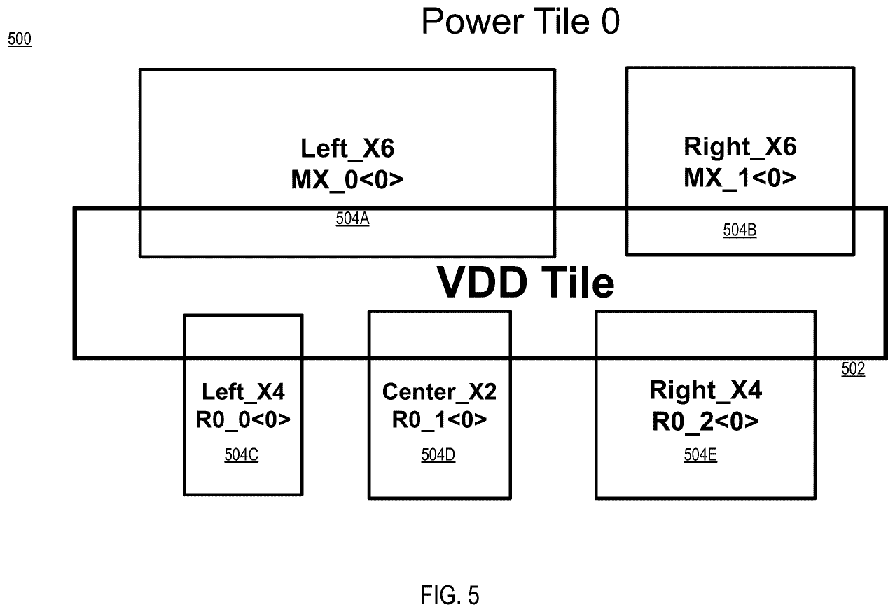

FIG. 5 shows an example power tile 500 of an integrated circuit design according to some embodiments of the present disclosure. The power tile 500 includes VDD tile staples 502 coupled to a number of gates 504A, 504B, 504C, 504D, 504E.

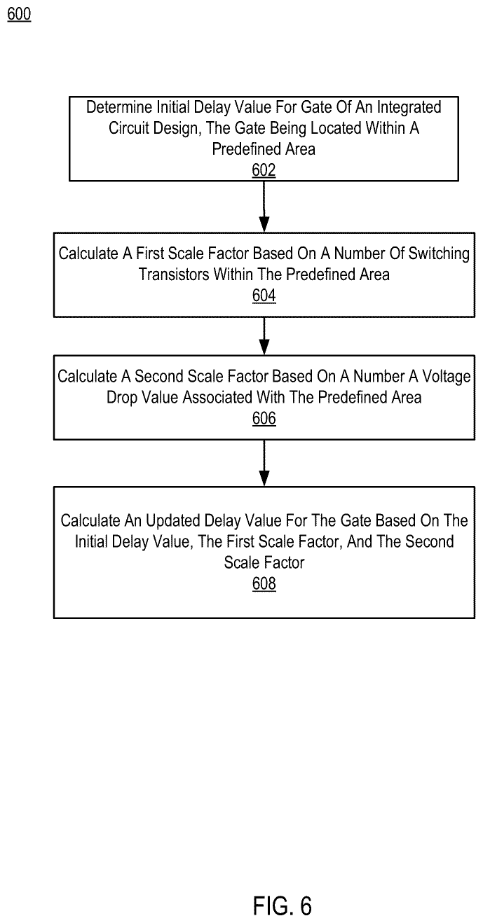

For further explanation, FIG. 6 is a flowchart of another example method 600 for example method for performing location aware timing analysis of a digital integrated circuit according to some embodiments of the present disclosure. The method 600 includes determining 602 an initial delay value for a gate of an integrated circuit design. The gate is located within a predefined area of the integrated circuit design. In some embodiments, the predefined area includes a tile of the integrated circuit design.

The method 600 further includes calculating 604 a first scale factor based on a number of switching transistors within the predefined area, and calculating 606 a second scale factor based on a voltage drop value associated with the predefined area. In some embodiments, the first scale factor is further based on a number of transistors in the predefined area and a first scale factor value associated with each switching transistor in the predefined area. In some embodiments, the second scale factor is further based on a second scale factor value associated with a predefined voltage drop in the predefined area.

The method 600 further includes calculating 608 an updated delay value for the gate based on the initial delay value, the first scale factor, and the second scale factor. In some embodiments, the updated delay value is further based on a sum of the first scale factor and the second scale factor, and a multiplication of the sum by the initial delay value.

In some embodiments, the method 600 further includes calculating a third scale factor based on a power staple configuration of the predefined area, wherein the updated delay value is further based on the third scale factor. In some embodiments, the power staple configuration is representative of a density of power staples within the predefined area.

In some embodiments, the method 600 further includes applying a design change to the gate to produce a changed integrated circuit design, and recalculating the updated delay value based on the design change. In some embodiments, the method 600 further includes generating a timing abstract including the updated delay value.

Although various embodiments are described herein with respect to scale factors, other embodiments may include a range of functions that manipulate delay responsive to location-based timing effects of gates of an integrated circuit design. In some embodiments, the principles described herein can be applied in a variable-detail accuracy manner, e.g., by performing initial timing using conservative estimates, and then re-analyzing a subset of the design using the techniques described herein.

In one or more embodiments, the principles described herein are not limited to power tile structure, switching fins in the power tile, and IR drop from power grid analysis, and may be extended to any physical characteristic of a gate that effects timing delay to scale delays based on the scale factors. In various embodiments, scaling delays due to any physical characteristic of the gate may result in a penalty or credit to the initial delay value to produce an updated delay value. In some embodiments, the timing delay calculations may be performed in either incremental or non-incremental timing. In some embodiments, the timing delay calculations may be performed in deterministic or statistical timing.

In some embodiments, fine grained incremental timing (e.g., accurate or slow) is performed in which all cells within a tile are queued for delay/slew invalidation when a gate within the tile is changed (e.g., added, subtracted, or moved). In some embodiments, invalidated tiles force recalculation of tile fin count. In some embodiments, local fin aware invalidation is enabled (e.g., accurate for optimization, faster, and easier to thread) in which an original tile and fin count during each round of location aware timing is cached, and any new calculations on usage adjust the cached tile fin count by any size changes or tile movements.

In view of the explanations set forth above, readers will recognize that the benefits of performing location aware timing analysis of an integrated circuit according to embodiments of the present disclosure include:

Produce a more accurate determination of gate delay in an integrated circuit design.

Faster and more efficient development of new integrated circuit designs.

Exemplary embodiments of the present disclosure are described largely in the context of a fully functional computer system for performing location aware timing analysis. Readers of skill in the art will recognize, however, that the present disclosure also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the disclosure as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present disclosure.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood from the foregoing description that modifications and changes may be made in various embodiments of the present disclosure without departing from its true spirit. The descriptions in this specification are for purposes of illustration only and are not to be construed in a limiting sense. The scope of the present disclosure is limited only by the language of the following claims.

What is claimed is:

1. A method for timing analysis of an integrated circuit, the method comprising:
determining an initial delay value for a gate of an integrated circuit design, the gate being located within a predefined area of the integrated circuit design;
calculating a first scale factor based on a number of switching transistors within the predefined area;
calculating a second scale factor based on a voltage drop value associated with the predefined area; and
calculating an updated delay value for the gate based on the initial delay value, the first scale factor, and the second scale factor.

2. The method of claim 1, wherein the first scale factor is further based on a number of transistors in the predefined area and a first scale factor value associated with each switching transistor in the predefined area.

3. The method of claim 1, wherein the second scale factor is further based on a second scale factor value associated with a predefined voltage drop in the predefined area.

4. The method of claim 1, further comprising:
calculating a third scale factor based on a power staple configuration of the predefined area, wherein the updated delay value is further based on the third scale factor.

5. The method of claim 4, wherein the power staple configuration is representative of a density of power staples within the predefined area.

6. The method of claim 1, wherein the updated delay value is further based on a sum of the first scale factor and the second scale factor, and a multiplication of the sum by the initial delay value.

7. The method of claim 1, further comprising:
applying a design change to the gate to produce a changed integrated circuit design; and
recalculating the updated delay value based on the design change.

8. The method of claim 1, further comprising:
generating a timing abstract including the updated delay value.

9. The method of claim 1, wherein the predefined area includes a tile of the integrated circuit design.

10. An apparatus for timing analysis of an integrated circuit, the apparatus comprising:
a computer processor; and
a computer memory operatively coupled to the computer processor, the computer memory having disposed therein computer program instructions that, when executed by the computer processor, cause the apparatus to:
determine an initial delay value for a gate of an integrated circuit design, the gate being located within a predefined area of the integrated circuit design;
calculate a first scale factor based on a number of switching transistors within the predefined area;
calculate a second scale factor based on a voltage drop value associated with the predefined area; and
calculate an updated delay value for the gate based on the initial delay value, the first scale factor, and the second scale factor.

11. The apparatus of claim 10, wherein the first scale factor is further based on a number of transistors in the predefined area and a first scale factor value associated with each switching transistor in the predefined area.

12. The apparatus of claim 10, wherein the second scale factor is further based on a second scale factor value associated with a predefined voltage drop in the predefined area.

13. The apparatus of claim 10, wherein the computer program instructions further cause the apparatus to calculate a third scale factor based on a power staple configuration of the predefined area, wherein the updated delay value is further based on the third scale factor.

14. The apparatus of claim 13, wherein the power staple configuration is representative of a density of power staples within the predefined area.

15. The apparatus of claim 10, wherein the updated delay value is further based on a sum of the first scale factor and the second scale factor, and a multiplication of the sum by the initial delay value.

16. A computer program product for timing analysis of an integrated circuit, the computer program product disposed upon a computer readable medium, the computer program product comprising computer program instructions that, when executed, cause a computer to:
determine an initial delay value for a gate of an integrated circuit design, the gate being located within a predefined area of the integrated circuit design;
calculate a first scale factor based on a number of switching transistors within the predefined area;
calculate a second scale factor based on a voltage drop value associated with the predefined area; and
calculate an updated delay value for the gate based on the initial delay value, the first scale factor, and the second scale factor.

17. The computer program product of claim 16, wherein the first scale factor is further based on a number of transistors in the predefined area and a first scale factor value associated with each switching transistor in the predefined area.

18. The computer program product of claim 16, wherein the second scale factor is further based on a second scale factor value associated with a predefined voltage drop in the predefined area.

19. The computer program product of claim 17, wherein the computer program instructions further cause the computer to calculate a third scale factor based on a power staple configuration of the predefined area, wherein the updated delay value is further based on the third scale factor.

20. The computer program product of claim 19, wherein the power staple configuration is representative of a density of power staples within the predefined area.
